(19) United States
(12) Patent Application Publication
(10) Pub. No.: US 2004/0131454 A1
(43) Pub. Date: Jul. 8, 2004

(54) Apparatus for laying tarpaulin

(76) Inventor: Jean-Yves Voghel, Mont St-Hilaire (CA)

Correspondence Address: Eric Fincham, 316 Knowlton Road, Lac Brome, QC, J0E 1V0, CA

(21) Appl. No.: 10/656,611

(22) Filed: Sep. 5, 2003

(30) Foreign Application Priority Data
Sep. 27, 2002 (CA) 2,405,538

(51) Int. Cl. B60P 1/00

(52) U.S. Cl. 414/437

(57) ABSTRACT

An apparatus for use in conjunction with a powered vehicle to take up a long length's wide flexible sheeting material such as may be used in sanitary landfill sites, the apparatus having a framework designed to be engaged and transported by a powered vehicle, pick up arms extending outwardly at each end of the framework, an arbor assembly including a cylindrical mandrel, an oil pump mounted interiorly of the cylindrical mandrel, and a hydraulic system mounted at one end of the mandrel.

### FIELD OF THE INVENTION

The present invention relates to an apparatus and more particularly relates to an apparatus for covering a large area with a flexible sheeting material.

### BACKGROUND OF THE INVENTION

The use of an apparatus for laying down a long length of a flexible material to cover a large land area is known in the art. One of the uses for such an apparatus is to temporarily cover a sanitary landfill site when it is not being worked and to remove the material when it is designed to work the area.

Many sanitary landfill sites have regulations which require that the fill not be left exposed due to the inherent problems of sanitation. Accordingly, many of the sanitary landfill sites are required to cover the same with a layer of soil. This requires a substantial expenditure and results in a plurality of layers of landfill and soil.

Alternatively, the personnel at the site may manually position a flexible sheeting material over the area which thus meets the legal requirement. However, this requires that the personnel work in contact with the debris or refuse which was dumped into the landfill site.

### SUMMARY OF THE INVENTION

It is an object of the present invention to provide an apparatus which will be capable of laying out long sheets of a flexible sheeting material.

According to one aspect of the present invention, there is provided an apparatus suitable for use in conjunction with a powered vehicle to lay out and take up a long length, wide flexible sheeting material, the apparatus comprising a framework adapted for mounting engagement on a powered vehicle such as to be carried over a ground surface by the vehicle, a pick up arm extending outwardly from the framework at each end thereof, means for mounting a shaft on each of the pick up arms, an arbor assembly including a cylindrical mandrel, oil pump means mounted interiorly of the cylindrical mandrel, and a hydraulic system mounted at one end of the mandrel.

The apparatus of the present invention may be used in conjunction with conventional powered equipment such as tractors to provide the ability to cover a surface with flexible sheeting material. Such a surface can be, for example, a sanitary landfill site. The apparatus is also designed to pick up the sheeting material when required.

The apparatus of the present invention provides an efficient and economic solution for the cover of landfill sites. In lieu of placing soil on top of the landfill, one can utilize the sheeting material and thereby increase by 10% to 15% the volume of material within the landfill site. This also substantially reduces the cost involved and thereby becomes an economic solution for dealing with such landfill sites.

### BRIEF DESCRIPTION OF THE DRAWINGS

Having thus generally described the invention, reference will be made to the accompanying drawings illustrating an embodiment thereof, in which:

FIG. 1 is a perspective view of an apparatus according to the present invention as used with power driven equipment, shown in phantom lines;

FIG. 2 is a side elevational view showing the apparatus about to be picked up by powered equipment and a load of sheet material loaded thereon;

FIGS. 3 and 4 are side elevational views showing the operation of the apparatus;

FIG. 5 is an enlarged perspective view of the end of the arbor assembly;

FIG. 6 is a partial front elevational view of the arbor and framework;

FIG. 7 is a top plan view of a portion of the arbor and sheeting material as it is placed on a substrate; and

FIG. 8 is a cross sectional view illustrating the end portions of the arbor assembly.

### DESCRIPTION OF THE PREFERRED EMBODIMENTS

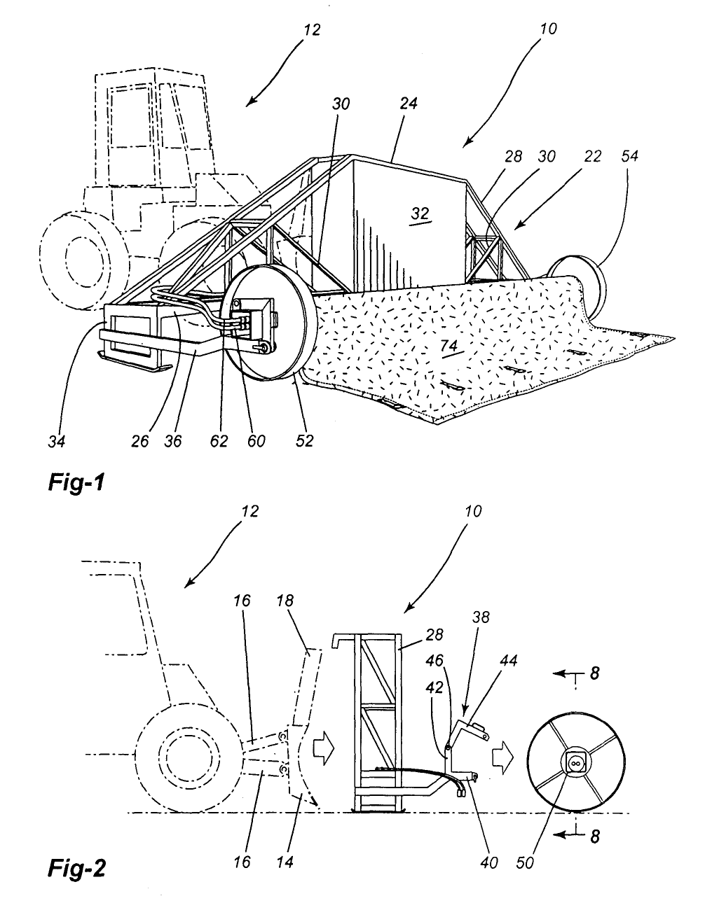

Referring to the drawings in greater detail and by reference characters thereto, there is illustrated in FIG. 1 an apparatus according to an embodiment of the present invention and which apparatus is generally designated by reference numeral 10. Apparatus 10 is designed to be used in conjunction with a tractor generally designated by reference numeral 12 and which is shown in outline. Tractor 12 includes a shovel 14 connected to tractor 12 by means of arms 16. Preferably, there is provided an upper extension 18.

In general terms, apparatus 10 includes a framework 22 which includes upper horizontal frame members 24 and lower horizontal frame members 26. A plurality of diagonal frame members 28 extend from respective ends of upper frame members 24 to respective ends of lower horizontal frame members 26. As is conventional, struts 30 interconnect the frame members.

Framework 22 also includes an enclosed center generally designated by reference numeral 32 and which is designed to house various hydraulic components and parts. In effect, center portion 32 forms a storage cabinet and which may be accessed by means of doors (not shown).

At the end of framework 22 there are provided a rectangular side frame generally designated by reference numeral 34. A further side frame (not shown) is provided on the other side of framework 22. A side arm 36 extends outwardly and forwardly from framework 22 (at both ends) and there is provided a grasping mechanism 38.

Grasping mechanism 38 includes a lower arm 40, a vertical arm 42, and an upper pivotable member 44 which is pivotably connected to vertical arm 42 at pivot point 46.

A mandrel 50 is provided around which the sheet material is rolled while at either end of mandrel 50 there is provided a disk 52, 54.

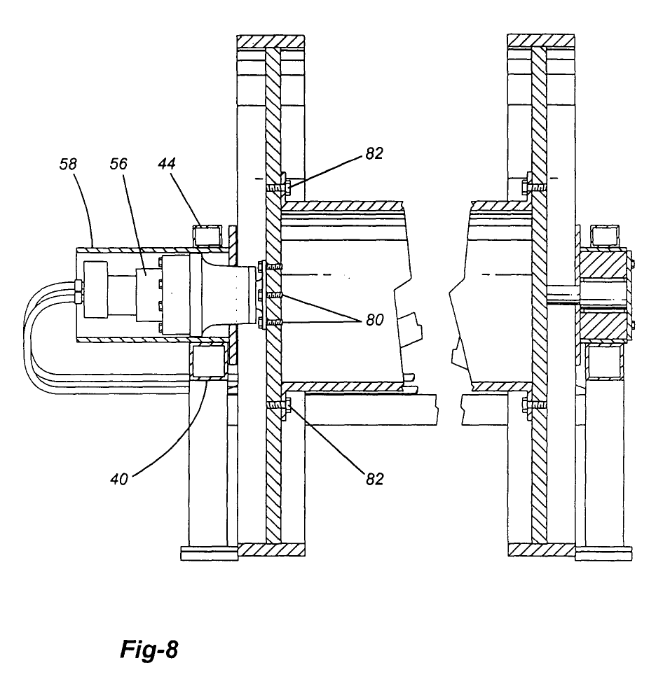

As may be best seen in FIG. 8, a hydraulic motor 56 is connected to disk 52 and is mounted in a housing 58. Hydraulic motor 56 has hydraulic hoses 60, 62 meeting thereto and which are supplied from the hydraulic system of tractor 12.

Hydraulic motor 56 is secured to the central part of disk 52 by means of bolts 80 while disk 52 is in turn secured to mandrel 50 by means of bolts 82.

Located interiorly of central portion 32 is a hydraulic reservoir 64. Also located therein is a starter 68 and an electric motor 70. Batteries 72 are also mounted therein.

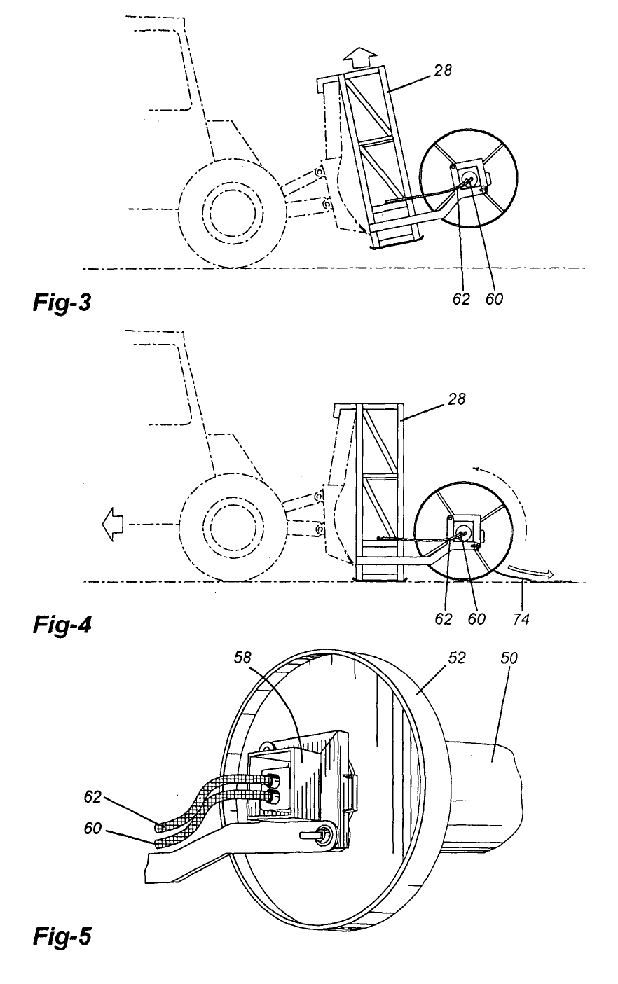

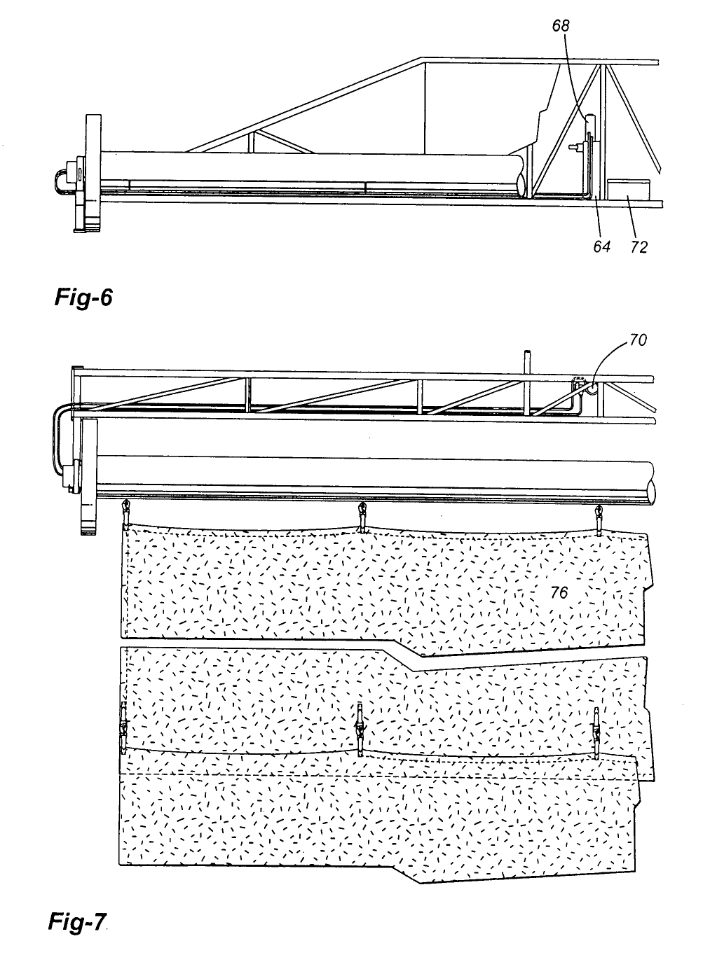

As may be seen in FIGS. 2, 3 and 4, the tractor 12 can pick up the apparatus 10 by means of shovel 14 with extension 18. As is illustrated in FIG. 3, the apparatus can be moved to the desired location. Subsequently, as shown in FIG. 4, a film or sheeting material may be dispensed as indicated by arrow 76. Naturally, the operation may be reversed when it is desired to take up the sheeting material 74.

It will be understood that the above described embodiments are for purposes of illustration only and changes or modifications may be made thereto without departing from the spirit and scope of the invention.

I claim:

1. An apparatus suitable for use in conjunction with a powered vehicle to lay out and take up a long length, wide flexible sheeting material, the apparatus comprising:
a framework adapted for mounting engagement on a powered vehicle such as to be carried over a ground surface by the vehicle;
a pick up arm extending outwardly from said framework at each end thereof;
means for mounting a shaft on each of said pick up arms;
an arbor assembly including a cylindrical mandrel;
oil pump means mounted interiorly of said cylindrical mandrel; and
a hydraulic system mounted at one end of said mandrel.

2. The apparatus of claim 1 wherein said mounting means comprises a first arm segment having a horizontal component and a vertical component, and a second arm segment pivotally connected to said first arm segment, said arm segments defining therebetween a rectangular opening when closed.

3. The apparatus of claim 1 wherein said framework further includes leg stand means mounted to the framework and positioned rearwardly thereof to maintain the apparatus in an upright position when not mounted to a vehicle.

4. The apparatus of claim 2 further including a storage means within said framework, said storage means having a door permitting access thereto.

5. The apparatus of claim 4 further including an electric motor, said electric motor being mounted within said storage means.

6. The apparatus of claim 4 further including a hydraulic reservoir within said storage means.

7. The apparatus of claim 1 wherein said pick up arm comprises a rectangular gripping means for gripping said arbor assembly.
